(19) United States
(12) Patent Application Publication
(10) Pub. No.: US 2005/0225858 A1
(43) Pub. Date: Oct. 13, 2005

(54) Night reflective fringe for people, animals and vehicles

(76) Inventors: James Gerard Dobihal, St. Paul, MN (US); Valorie Lynn Klemz, St. Paul, MN (US)

Correspondence Address: Valorie Klemz, 1831 Hillcrest Avenue, St. Paul, MN, 55116, US

(21) Appl. No.: 10/822,176

(22) Filed: Apr. 12, 2004

(51) Int. Cl. G02B 5/12

(52) U.S. Cl. 359/515; 359/530

(57) ABSTRACT

Night reflective fringe for clothing, pet accessories and vehicles comprising a multitude of fringe-like strips of which at least one surface has retro-reflective properties for the purpose of providing both an aesthetically pleasing daytime and nighttime appearance as well as enhanced visibility at night to protect the wearer or vehicle. The invention increases the likelihood of both use and visibility by incorporating night reflective properties into established designs in which fringe is used, thereby increasing the number of different angles available for gathering incidental light rays and reflecting same back to the light source.

### CROSS REFERENCE TO RELATED APPLICATIONS

Not applicable.

### FEDERALLY SPONSORED RESEARCH

Not applicable.

### SEQUENCE LISTING OR PROGRAM

Not applicable.

### BACKGROUND OF THE INVENTION

1. Field of Invention

This invention relates to fringe ornamentation for people and vehicles, specifically to improved conspicuity of aesthetic design and safety properties at night.

2. Discussion of Prior Art

People have attempted to improve their safety and visibility outdoors at night by placing reflectors on their vehicles, applying reflective tape to clothing and wearing special clothing such as reflective vests.

Vehicle reflectors are rigid and utilitarian; offering limited aesthetic value, which reduces their prominence on vehicles to minimal compliance levels. In addition, their stationary nature limits their potential for light reflection. Daylight presence of these fixed objects detracts from vehicle appearance, especially vehicles with custom-crafted finishes such as motorcycles, where application of block type reflectors would detract from the vehicle's aesthetic appeal. This restricts their use to minimal compliance levels. Due to their rigid nature, such reflectors are not conducive to ornamentation of clothing or vehicles. A device using holographic or embossed foil strips (Malott, U.S. Pat. No. 4,886,687, Dec. 12, 1989) offers amusement by day, but becomes far less visible by night, offering no nighttime safety benefits.

Several devices have been designed to create night-reflectivity for vehicles. Uchtyl, U.S. Pat. No. 4,055,840, Oct. 25, 1977, shows a warning device intended to replace an incendiary flare. This device is not intended to be part of the vehicle; rather it is a device that may accompany the driver for safety purposes only. Ashworth, U.S. Pat. No. 4,342,280, Aug. 3, 1982 and Burkholder, U.S. Pat. No. 4,120,561, Oct. 17, 1978, show light reflective warning devices for bicycles and other vehicles. These and other such patents of similar safety devices (Barnhart, U.S. Pat. No. 4,876,981, Oct. 31, 1979 and Bolts, U.S. Pat. No. 4,479,699, Oct. 39, 1984), require the addition of a specific safety device to the vehicle, aesthetically affecting it purely for the purpose of safety.

Inventions to improve reflectivity on clothing include Lesley, U.S. Pat. No. 4,517,685, May 21, 1985, and Panton, U.S. Pat. No. 5,588,156, Dec. 31, 1996, which recognize the need to increase wearer visibility at night, but which incorporate new, specific design elements unlike the present invention.

Objects and Advantages

Accordingly, several objects and advantages of the present invention include the new use and transformation of desirable, daylight-visible design features into day and night design features. The advantages of this new use are increased safety, visibility, desirability and acceptance on clothing, pet accessories and vehicles.

The invention incorporates fringe-like trim with retro-reflective properties for day and night time form and function. Unlike rigid vehicle reflectors, reflective Fringe offers improved nighttime visibility by increasing the number of angles of reflective surfaces available to reflect incident light rays.

Unlike prior nighttime safety devices, reflective Fringe puts a desirable design feature to new use without a negative design impact. In fact, the design is greatly enhanced due to increased visibility at night for both aesthetic and safety purposes.

And unlike existing clothing reflectivity, reflective Fringe increases nighttime visibility due to a plurality of moving parts, which create a visually stunning appearance at night. The flowing Fringe increases both the occurrence and impact of the reflection.

It is therefore a principal objective of the present invention to provide a novel, useful and desirable Fringe ornamentation for enhanced safety and visibility.

It is another objective of the present invention to provide said Fringe in a novel manner that combines two formerly separate elements—fringe and retro-reflective materials—creating decorative novelty and utility.

It is another objective of the present invention to provide dramatically improved nighttime aesthetics, visual appeal and visibility for clothing, pet accessories and vehicles.

Further objects and advantages of the present invention will become apparent from a consideration of the drawings and ensuing description.

### SUMMARY

The present invention transforms desirable, daylight-visible design features into day and night design and safety features by incorporating retro-reflective materials onto Fringe-like trim for clothing, pet accessories and vehicles.

### DRAWINGS

FIG. 1 shows a perspective view of a preferred embodiment of Fringe-like trim.

FIG. 2 shows an additional perspective view of a preferred embodiment of Fringe-like trim.

FIG. 3 shows a rear view of a jacket incorporating the Fringe.

FIG. 4 shows a view of motorcycle handlebars incorporating the Fringe.

### REFERENCE NUMERALS

10. Fringe (short)
20. Retro-reflective Materials
30. Fringe-like Members
40. Fringe (long)

### DETAILED DESCRIPTION

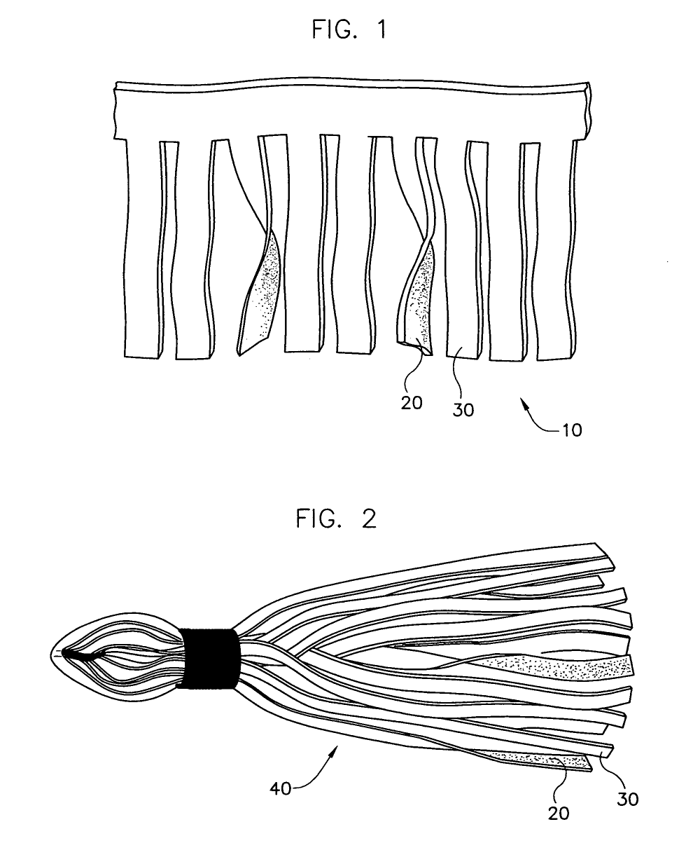

Preferred Embodiment—FIGS. 1-4

The Fringe comprises a plurality of retro-reflective streamers or fringe-like strips of any length, width or diameter, comprising arrangements in a line(s) or row(s) such as Fringe on a jacket, or in a cluster such as streamers on the handlebars of a motorcycle. The Fringe is further comprised of flat (ribbon-like), tubular (yarn-like) or multi-sided (triangular, hexagonal, etc) strands of any length/diameter/width, which may be long and straight or may take on other shapes such as pennant, ringlet or accordion-fold shapes.

In FIG. 1, Fringe 10 is shown, indicating the incorporation of Retro-reflective Materials 20. The Fringe-like Members 30 are made of a flexible material, such as fabric, neoprene, yarn or leather, which are easily affected by airflow. The Fringe may be gathered by any means (not shown). The use of Retro-reflective Materials 20 transforms the Fringe from simply an attractive, daylight visible design element to a day and night visible design and safety feature.

In FIG. 2, Fringe 40 is shown, indicating the possible incorporation of Retro-reflective Materials 20 and the arrangement of Fringe in a tassel-like manner. The Fringe may be gathered by any means (not shown). The Fringe-like Members 30 are made of flexible materials, such as fabric, neoprene, yarn or leather, which are easily affected by airflow. The use of Retro-reflective Materials 20 transforms the Fringe from simply an attractive, daylight visible design element to a day and night visible design and safety feature. It will be appreciated that the invention is not necessarily limited solely to the construction of Fringe by these means.

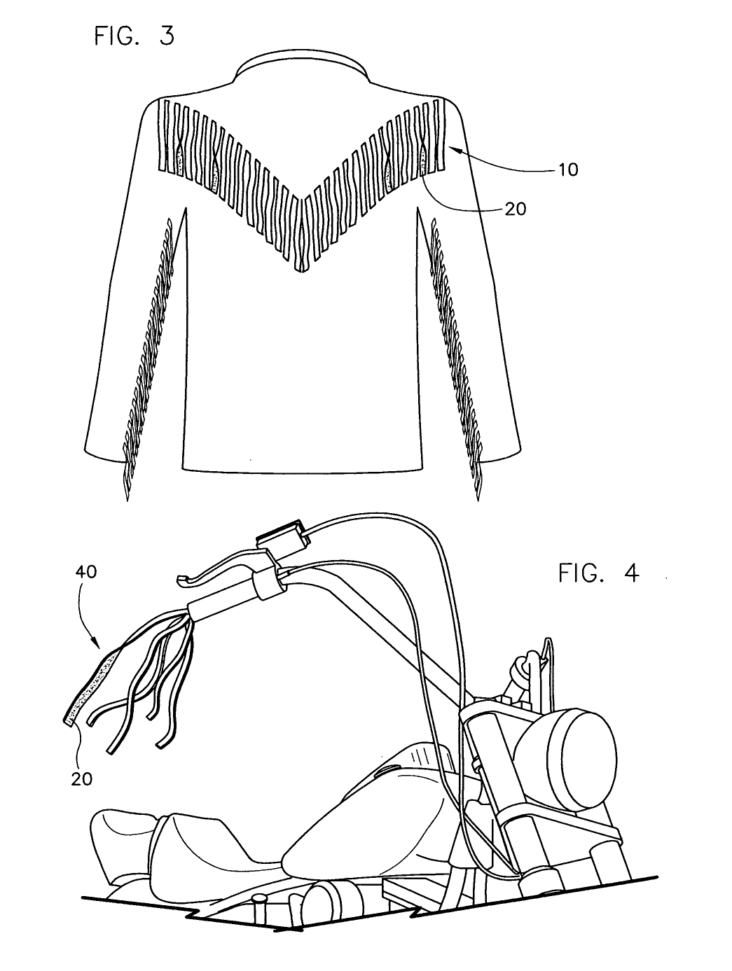

FIG. 3 illustrates Fringe 10 as applied on a jacket. In the example, it is clear that the Fringe itself exists as a preferred design element on the jacket; the added Retro-reflective Materials 20 enhances night appearance and appeal while adding a unique safety element. The Fringe is attached to the jacket by conventional means such as stitching (not shown).

FIG. 4 illustrates Fringe 40 as applied on motorcycle handlebars. In the example, it is clear that the Fringe itself exists as a preferred design element on the motorcycle; the added Retro-reflective Materials 20 enhances night appearance and appeal while adding a unique safety element. The Fringe is attached to the handlebars or grips by conventional means such as elastic bands or ties (not shown).

In any application, the number of retro-reflective members comprising the Fringe is determined by the size of the article and the amount of reflectivity desired by the wearer/user.

Operation of Invention

In use, the Fringe serves as an aesthetically pleasing daytime ornamentation, as well as both an aesthetically and safety enhanced nighttime decoration. The Fringe provides an effective means for increasing nighttime appeal of the article by improving the visibility of the Fringe and offering an eye-catching, highly noticeable effect. The Fringe also provides an effective means for increasing nighttime safety by dramatically increasing the wearer's nighttime visibility through the creation of a multitude of retro-reflective surfaces from which to reflect light back to the source. Visibility is increased with air movement.

The Fringe may be made of any flexible fiber or material, such as fabric, leather, plastic, string, foam, hemp, etc, which is partially or completely retro-reflectively enhanced by any method using advanced reflective technology such as 3M SCOTCHLITE brand retro-reflective fabrics, inks, paints, etc. Said enhancements may be made by any method, such as ink application by spray or screen, heat transfer of inks and coatings, fabric backed with heat-activated adhesive, or reflective yarns woven into said material. Both the Fringe and the retro-reflective surface may be of any color.

Aesthetically, the effect of the use of retro-reflective enhancements on the Fringe is stealth-like; the Fringe may be unobtrusively decorative in daylight, being incorporated in a form that is well accepted for use on bicycles, motorcycles, other vehicles and clothing, and it creates nighttime visibility when the wearer or vehicle is stationary as ambient light is reflected back to the source. When the person or vehicle is in motion, the Fringe provides a visually stunning appearance at night as light reflects off the flowing Fringe. The flowing Fringe creates substantially greater opportunity for light reflection, increasing both the occurrence and impact of the reflection.

Further, the effect of using retro-reflective fringe on moving people, vehicles or animals also increases safety by providing unavoidably enhanced night visibility properties when struck by a beam of light from headlights, street lights, flashlights, etc. Nighttime affects are directly related to the length and number of Fringe-like pieces hanging from the garment, vehicle, bicycle, leash, etc.

Conclusion, Ramifications and Scope

Therefore, the Fringe incorporates the new use and transformation of desirable design features into day/night design features for increased safety, visibility, desirability and acceptance on clothing, pet accessories and vehicles.

The Fringe is unique and significantly novel compared to any prior art now generally used for a combination of aesthetically pleasing design and safety. The use of Fringe transforms a daylight-visible design element into a day and night-visible design and safety feature. This nighttime visibility will both appeal to a wearer's aesthetic eye as well as to his/her desire for improved safety. Further, the Fringe provides substantially greater, more intense, and more appealing light reflection applications than are currently known in prior art.

The Fringe-like members may be of any length, and any means may be used to gather the members. The Fringe may be applied to any item of clothing, footwear, pet accessory, motorized vehicle or non-motorized vehicle.

It should be understood from the foregoing that the invention is not limited to the specific embodiments described and shown in the drawings. The invention may be practiced on any flexible material used in the manner of fringe, streamers or any similar application for the purpose of improving the design and/or safety properties of the article.

Therefore, the invention may be practiced otherwise than as specifically described herein. Accordingly, the scope of the invention should be determined not by the embodiments illustrated, but by the appended claims and their legal equivalents.

1. Retro-reflective fringe comprising:
a. A plurality of fringe-like members of any length, width or diameter,
b. Said members comprised of retro-reflective properties on all or part of one or more surfaces.
